(19) United States
(12) Patent Application Publication
(10) Pub. No.: US 2017/0142277 A1
(43) Pub. Date: May 18, 2017

(54) IMAGE READING APPARATUS

(71) Applicants: KABUSHIKI KAISHA TOSHIBA, Tokyo (JP); TOSHIBA TEC KABUSHIKI KAISHA, Tokyo (JP)

(72) Inventor: Kenji Itagaki, Mishima (JP)

(21) Appl. No.: 14/938,922

(22) Filed: Nov. 12, 2015

(51) Int. Cl. H04N 1/00; H04N 1/047

(52) U.S. Cl. CPC H04N 1/00891; H04N 1/0476; H04N 2201/0094; H04N 2201/04739

(57) ABSTRACT

An image acquisition part to acquire an image of an original document based on an output of an imaging device; a position control part to control a position of a first carriage movable in a sub-scanning direction; a correction information acquisition part to acquire correction information used for correction of the output of the imaging device by turning on a light source of the first carriage at a first position; a storage part to store the correction information acquired by the correction information acquisition part; and a state control part to control a state of the self apparatus between a normal state in which the image acquisition part can acquire the image of the original document and a low power state in which the image acquisition part can not acquire the image of the original document but power consumption is lower than that in the normal state.

### FIELD

Embodiments described herein relate generally to an image reading apparatus.

### BACKGROUND

In an image processing apparatus such as a multi-function peripheral, a process is proposed in which if there is continuously no operation in a specified time, a transition occurs to a low power state. A partial function of a specified component is stopped in the low power state. There is an AFA (Analog Front End) as an example of the specified component. The power consumption can be reduced by performing such a process.

However, there is a case where time is required to transition from the low power state to a normal state in which a normal process is performed and to start image reading of an original document.

### BRIEF DESCRIPTION OF THE DRAWINGS

FIG. 1 is an outer appearance view showing a whole structural example of an image processing apparatus 100 of an embodiment.

FIG. 2 is a schematic view showing a structural example of an image reading part 200.

FIG. 3 is a schematic view of an AFE included in the image processing apparatus 100.

FIG. 4 is a view showing a specific example of positions relating to control of a first carriage 21.

FIG. 5 is a flowchart showing a specific example of a process performed when a normal state transitions to a low power state.

FIG. 6 is a flowchart showing a specific example of a process performed when the low power state transitions to the normal state.

### DETAILED DESCRIPTION

In general, according to one embodiment, an image reading apparatus includes an image acquisition part, a position control part, a correction information acquisition part, a storage part and a state control part. The image acquisition part acquires an image of an original document based on an output of an imaging device. The position control part controls a position of a first carriage movable in a sub-scanning direction. The correction information acquisition part acquires correction information used for correction of the output of the imaging device by turning on a light source of the first carriage at a first position. The storage part stores the correction information acquired by the correction information acquisition part. The state control part controls a state of the self apparatus between a normal state and a low power state. The normal state is a state in which the image acquisition part can acquire the image of the original document. The low power state is a state in which the image acquisition part can not acquire the image of the original document but power consumption is lower than that in the normal state. When the state control part transitions the self apparatus from the normal state to the low power state, the following processing is performed. The position control part moves the first carriage to the first position. The acquisition part acquires the correction information. The storage part stores the correction information. The position control part moves the first carriage to a second position or a position closer to the second position than the first position at least after the acquisition part acquires the correction information. The second position is a position where the image acquisition part starts to acquire the image of the original document placed on a document stand.

Hereinafter, an image processing apparatus 100 of an embodiment will be described with reference to the drawings. In the respective drawings, the same components are denoted by the same reference numerals. The image processing apparatus 100 is an example of an image reading apparatus.

Outline

First, the outline of the image processing apparatus 100 will be described. The image processing apparatus 100 can take plural states. For example, the image processing apparatus 100 can take one of a normal state and a low power state. The normal state is a state in which an image of an original document can be read according to an instruction of a user. The low power state is a state in which the image of the original document can not be read according to the instruction of the user, but power consumption is lower than that in the normal state. In the low power state, time required to transition to the normal state is short as compared with a state in which power is off.

When the normal state transitions to the low power state, the image processing apparatus 100 performs the following respective processes. First, the image processing apparatus 100 moves the first carriage including a light source to a position (hereinafter referred to as “gain adjustment position”) below a shading plate. Next, the image processing apparatus 100 acquires correction information by performing an AGC (Auto Gain Control) process. Next, the image processing apparatus 100 records the acquired correction information in a storage part. At this time, the image processing apparatus 100 records the correction information in the storage part in which information is not lost also in the low power state. Next, the image processing apparatus 100 moves the first carriage to a position (hereinafter referred to as “document detection position”) where the first carriage is to exist at an acquisition start time point of the image of the original document placed on a document stand. A position to which the first carriage is moved may be a position different from the document detection position as long as the position is closer to the document detection position than the gain adjustment position. The image processing apparatus 100 transitions from the normal state to the low power state.

The image processing apparatus 100 performs the following respective processes when the low power state transitions to the normal state. First, the image processing apparatus 100 does not move the position of the first carriage to the gain adjustment position, but moves the position to the document detection position. If the position of the first carriage is already the document detection position, the movement is not needed. The image processing apparatus 100 reads the correction information from the storage part. The image processing apparatus 100 acquires image data of the original document by using the read correction information.

According to the above structure, the image processing apparatus 100 is not required to perform the AGC process when the low power state transitions to the normal state. Thus, the image processing apparatus 100 can move the first carriage to the document detection position without moving the first carriage to the gain adjustment position. Accordingly, time required to transition the low power state to the normal state and to start reading of the image of the original document can be shortened.

Details

Hereinafter, details of the image processing apparatus 100 will be described.

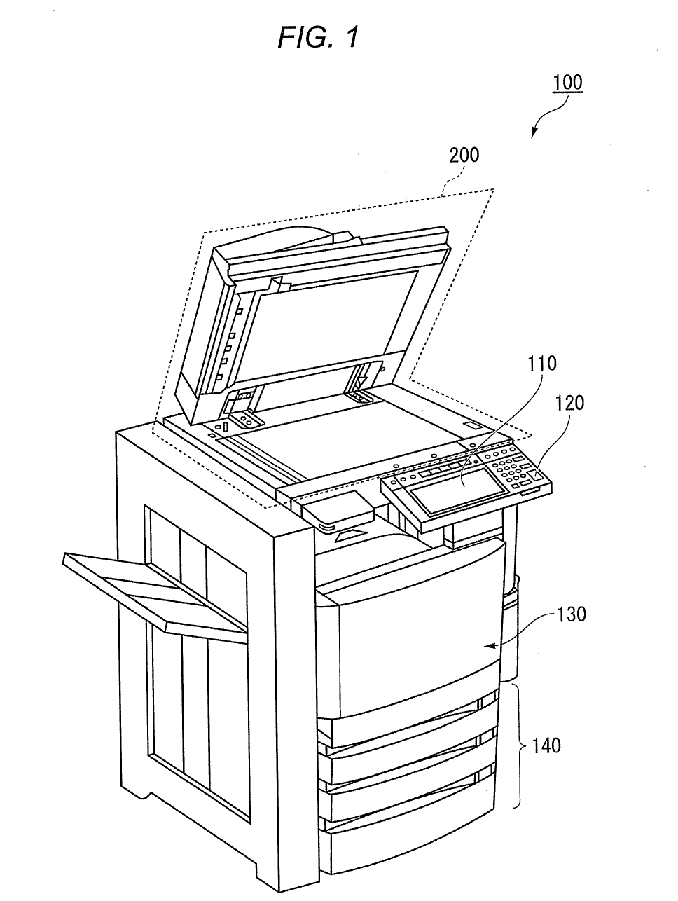

FIG. 1 is an outer appearance view showing a whole structural example of the image processing apparatus 100 of the embodiment. The image processing apparatus 100 is, for example, an image forming apparatus such as a multi-function peripheral. The image processing apparatus 100 includes a display 110, a control panel 120, a printer part 130, a sheet containing part 140 and an image reading part 200. Incidentally, the printer part 130 of the image processing apparatus 100 may be an apparatus to fix a toner image or may be an ink-jet apparatus.

The image processing apparatus 100 reads an image expressed on a sheet to generate digital data, and generates an image file. The sheet is, for example, an original document or paper on which characters and images are represented. The sheet may be anything as long as the image processing apparatus 100 can read.

The display 110 is an image display device such as a liquid crystal display or an organic EL (Electro Luminescence) display. The display 110 displays various information relating to the image processing apparatus 100.

The control panel 120 includes plural buttons. The control panel 120 accepts a user operation. The control panel 120 outputs a signal corresponding to the operation performed by the user to a control part of the image processing apparatus 100. Incidentally, the display 110 and the control panel 120 may be constructed as an integral touch panel.

The printer part 130 forms an image on a sheet based on image information generated by the image reading part 200. The printer part 130 forms the image by, for example, processing as described below. First, the printer part 130 forms an image (electrostatic latent image) visualized by a developer on the sheet based on the image information generated by the image reading part 200. A specific example of the developer is a toner. The printer part 130 heats and pressurizes the sheet on which the electrostatic latent image is formed. The developer is fixed to the surface of the sheet by heating and pressurizing. Incidentally, the sheet on which the image is formed on the surface may be a sheet contained in the sheet containing part 140 or may be a manually fed sheet.

The sheet containing part 140 contains sheets used for image formation in the printer part 130.

The image reading part 200 reads the image information of a read object as brightness and darkness of light. The image reading part 200 records the read image information. The recorded image information may be transmitted to another image processing apparatus through a network. The image of the recorded image information may be formed on the sheet by the printer part 130.

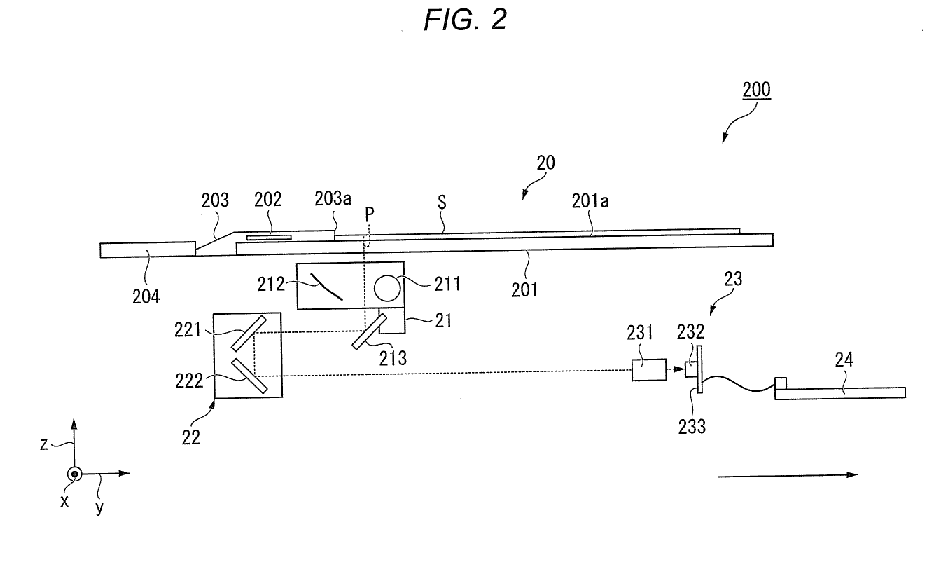

FIG. 2 is a schematic view showing a structural example of the image reading part 200.

The image reading part 200 includes a document stand 20, a first carriage 21, a second carriage 22, an imaging part 23 and a control part 24. The document stand 20 may include an ADF (Automatic Document Feeder). A direction in which the first carriage 21 moves is a sub-scanning direction y. A direction orthogonal to the sub-scanning direction y on the document stand 20 is a main scanning direction x. A direction orthogonal to the main scanning direction x and the sub-scanning direction y is a height direction z.

The document stand 20 includes a document stand glass 201, a shading plate 202, a document scale 203 and a through-read glass 204.

The document stand glass 201 includes a placing surface 201a on which a sheet S is placed. The shading plate 202 is composed of a white member. The shading plate 202 has a white color which becomes a reference at the time of a shading correction for an image (hereinafter referred to as “read image”) read from the sheet S and an AGC process. The shading plate 202 has a shape which is long in the main scanning direction x. The document scale 203 indicates the position of the sheet S placed on the document stand glass 201. A tip reference part 203a is provided at an end of the document scale 203. The tip reference part 203a forms a step relative to the placing surface 201a of the document stand glass 201, and forms a protrusion to which an end of the sheet S is pushed. The sheet S is pushed to the tip reference part 203a on the document stand glass 201 so that the position is determined. A position where the corner of the tip of the sheet S is placed is previously determined on the placing surface 201a. The corner of the tip of the sheet S is placed on the previously determined position, so that positioning in the main scanning direction x and the sub-scanning direction y is performed.

The first carriage 21 includes a light source 211, a reflector 212 and a first mirror 213. The light source 211 emits light. The reflector 212 reflects the light emitted from the light source 211. The light reflected by the reflector 212 is uniformly irradiated to the shading plate 202 and the sheet S. Light distribution characteristics in the main scanning direction x at the read position of the sheet S is adjusted based on the reflected light of the irradiated light. The first mirror 213 reflects the light reflected by the shading plate 202 and the sheet S to a second mirror 221 of the second carriage 22.

The second carriage 22 includes the second mirror 221 and a third mirror 222. The second mirror 221 reflects the light reflected by the first mirror 213 to the third mirror 222. The third mirror 222 reflects the light reflected by the second mirror 221 to a condensing lens 231 of the imaging part 23.

The imaging part 23 includes the condensing lens 231, a CCD sensor 232 and a CCD substrate 233. The condensing lens 231 condenses the light reflected by the third mirror 222. The condensing lens 231 forms an image of the condensed light on an imaging surface (reading surface) of the CCD sensor 232. The CCD sensor 232 is mounted on the CCD substrate 233. For example, the CCD sensor 232 is a three-line sensor having six-channel outputs. In this case, the CCD sensor 232 (three-line sensor having six-channel outputs) reads lights of R (Red), G (Green) and B (Blue). The CCD sensor 232 (three-line sensor having six-channel outputs) converts the lights imaged by the condensing lens 231 into electric charges. By this conversion, the CCD sensor 232 (three-line sensor having six-channel outputs) converts the image formed by the condensing lens 231 into electric signals. The CCD sensor 232 (three-line sensor having six-channel outputs) outputs the electric signals generated from the lights of the respective colors through two channels of ODD pixels and EVEN pixels. The CCD substrate 233 generates image data based on the electric signals generated by the photoelectric conversion of the CCD sensor 232. In the generation of the image data, the CCD substrate 233 uses the correction information previously obtained by the AGC process and generates the image data. The CCD substrate 233 outputs the generated image data to the control part 24. The foregoing process performed by the CCD substrate 233 is performed by an AFE (Analog Front End) mounted on the CCD substrate 233.

The control part 24 controls the first carriage 21, the second carriage 22 and the imaging part 23. For example, the control part 24 controls the movement of the first carriage 21, and the turning on and off of the light source 211 of the first carriage 21. For example, the control part 24 controls the operation of the imaging part 23.

The control part 24 controls the state of the self apparatus (image processing apparatus 100) between a normal state and a low power state. The normal state is a state in which an image of an original document can be read in accordance with an instruction of a user. In the normal state, a timing generator mounted on the CCD substrate 233 outputs a CCD control signal to the CCD sensor 232. The low power state is a state in which although an image of an original document can not be read in accordance with an instruction of a user, the power consumption is lower than that in the normal state. In the low power state, the timing generator mounted on the CCD substrate 233 is stopped. Thus, the CCD control signal is not outputted in the low power state. Accordingly, the operation of the CCD sensor 232 is stopped in the low power state.

The first carriage 21 moves in the sub-scanning direction y in accordance with the control of the control part 24. The second carriage 22 moves in the same direction as the first carriage 21 and at a speed of ½ in accordance with the movement of the first carriage 21. By the operation as stated above, a light path length of light to reach the imaging surface of the CCD sensor 232 is not changed also in the case where the first carriage 21 moves. That is, the light path length of light in the optical system constituted by the first mirror 213, the second mirror 221, the third mirror 222 and the condensing lens 231 is constant. In other words, the light path length from the placing surface 201a to the imaging surface of the CCD sensor 232 is constant.

For example, in the example of FIG. 2, the first carriage 21 moves from the left to the right along the sub-scanning direction y. A read position P of the sheet S also moves in the sub-scanning direction y in accordance with the movement of the first carriage 21. Thus, the read position P moves from the left to the right along the sub-scanning direction y. The read position P is a position for one line in the main scanning direction x. The read position P moves in the sub-scanning direction y, so that an image at the read position P of the sheet S is sequentially formed on the imaging surface of the CCD sensor 232. The CCD sensor 232 outputs a signal corresponding to the imaged image at the read position P as a signal for one line in the main scanning direction x. The CCD substrate 233 generates' image data of the whole sheet S based on signals for plural lines.

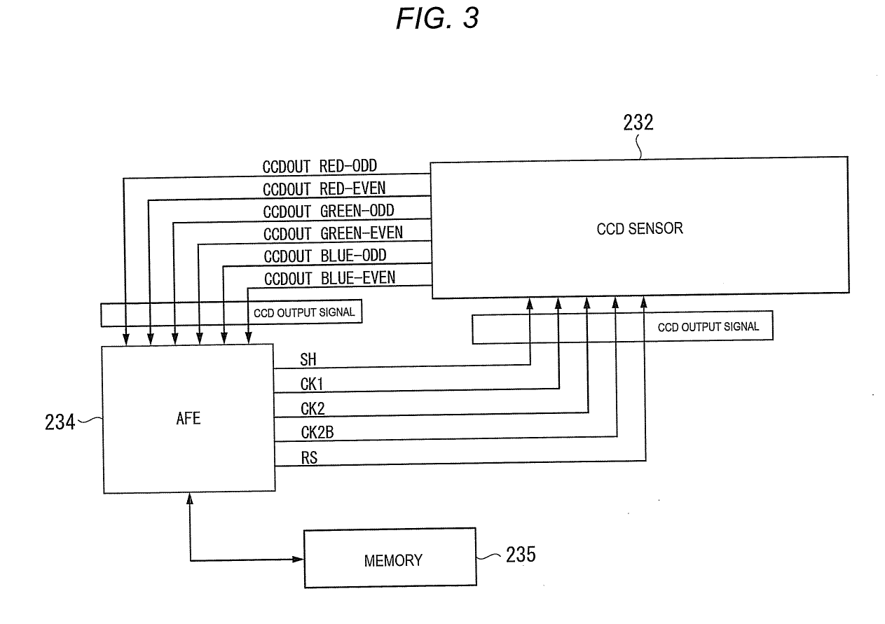

FIG. 3 is a schematic view of the AFE included in the image processing apparatus 100. The AFE 234 is connected to the CCD sensor 232 via plural signal lines. A memory 235 is connected to the AFE 234. Signals outputted from the AFE 234 to the CCD sensor 232 are signals (CCD control signals) to control the CCD sensor 232. Signals outputted from the CCD sensor 232 to the AFE 234 are CCD output signals. The AFE 234 generates image data based on the signals (CCD output signals) outputted from the CCD sensor 232. In the generation of the image data, the AFE 234 uses the correction information previously acquired by the AGC process and generates the image data. The AFE 234 outputs the generated image data to the control part 24.

The memory 235 is connected to the AFE 234 and the control part 24. The memory 235 does not lose the stored information also when a power saving state occurs. That is, information written in the memory 235 before the power saving state is held in the memory 235 also after the power saving state occurs. For example, the memory 235 is constituted by using a nonvolatile memory. For example, the memory 235 stores the correction information obtained by the AGC process.

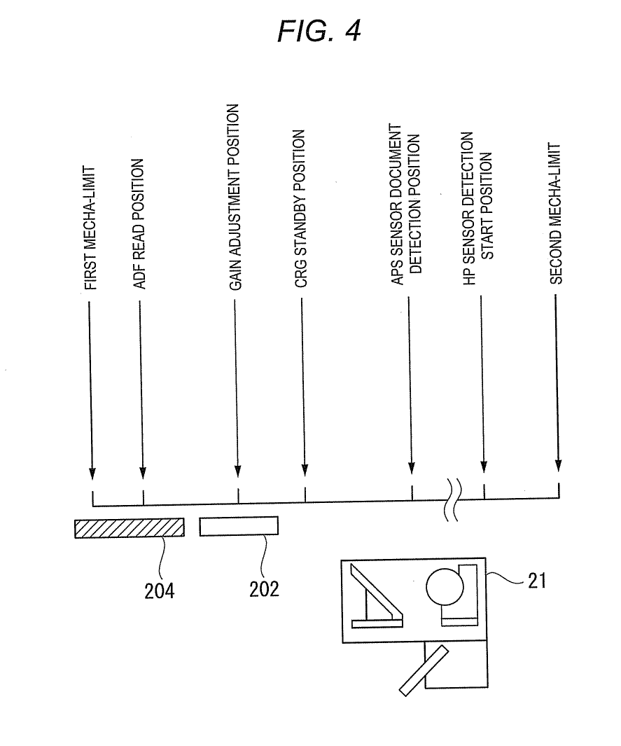

FIG. 4 is a view showing a specific example of positions relating to the control of the first carriage 21. The positions relating to the control of the first carriage 21 include a first mecha-limit position, a packing mode position, an ADF read position, a gain adjustment position, a CRG standby position, a document tip position, an APS sensor document detection position, an HP sensor detection start position, a document rear end position, a speed reduction start position, and a second mecha-limit position. The first mecha-limit position and the second mecha-limit position are ends of a range in which the first carriage 21 can move. The ADF read position is a position where the first carriage 21 is stationary when an image of a sheet S conveyed by the ADF is read. The gain adjustment position is a position below the shading plate 202. The gain adjustment position is the position where the first carriage 21 is stationary when the AGC process is performed. The CRG standby position is a standby position of the first carriage 21. After the image is read, the first carriage 21 moves to the CRG standby position. Also after the position of the home position (HP) sensor is detected, the first carriage 21 moves to the CRG standby position. The APS sensor document detection position is a position where the first carriage 21 is stationary when the size of the original document is detected. The HP sensor detection start position is a position where the position of the first carriage 21 is detected. In general, immediately after power is turned on, the control part 24 does not have the position information of the first carriage 21. The control part 24 moves the first carriage 21 and detects that the first carriage 21 passes the HP sensor detection start position. The control part 24 acquires the position information of the first carriage 21 based on the detection.

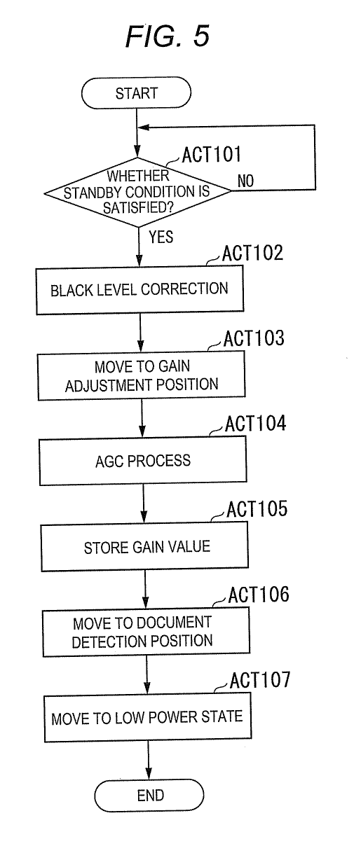

FIG. 5 is a flowchart showing a specific example of processing performed when the normal state transitions to the low power state. First, the control part 24 determines whether a standby condition is satisfied (ACT101). The standby condition is a previously determined condition as a condition under which the normal state transitions to the low power state. For example, the standby condition is such that the image processing apparatus 100 does not continuously operate for a specified time. For example, the standby condition is such that the user inputs an instruction indicating the transition to the low power state.

If the standby condition is not satisfied (ACT101-NO), the control part 24 does not perform the transition from the normal state to the low power state. On the other hand, if the standby condition is satisfied (ACT101-YES), the control part 24 determines to perform the transition from the normal state to the low power state. In this case, the control part 24 performs processes of ACT102 to ACT106 described below before the transition to the low power state.

First, the control part 24 performs a black level correction process (ACT102). Next, the control part 24 moves the first carriage 21 to the gain adjustment position (ACT103). Next, the control part 24 performs the AGC process (ACT104). In the AGC process, the light source 211 of the first carriage 21 is turned on, so that the correction information used for the correction of the output of the CCD sensor 232 is acquired. Specifically, the following is performed. In the AGC process, first, the control part 24 turns on the light source 211 of the first carriage 21. The light source 211 is turned on in the state where the first carriage 21 is positioned at the gain adjustment position, so that the shading plate 202 (white substrate) is illuminated. The AFE 234 acquires an output value of the CCD sensor 232 in the state where the shading plate 202 is illuminated. The AFE 234 acquires such a gain value that the output value of the CCD sensor 232 becomes a previously determined target value (for example, 960/1024). The gain value acquired by the AFE 234 corresponds to the correction information.

After the process of ACT104, the control part 24 stores the acquired correction information (gain value) in the memory 235 (ACT105). After the process of ACT104 or ACT105, the control part 24 moves the first carriage 21 to the document detection position (ACT106). After the process of ACT106, the control part 24 transitions the self apparatus to the low power state (ACT107).

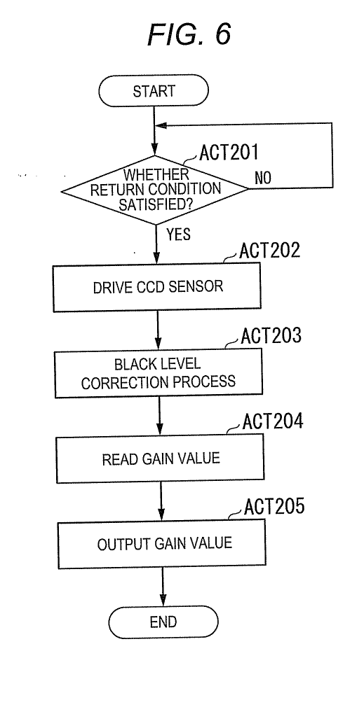

FIG. 6 is a flowchart showing a specific example of processing when the low power state transitions to the normal state. First, the control part 24 determines whether a return condition is satisfied (ACT201). The return condition is a previously determined condition as a condition under which the low power state transitions to the normal state. For example, the return condition is such that an instruction of operation is inputted to the image processing apparatus 100. For example, the return condition is such that the control panel 120 is operated by the user. For example, the return condition is such that a not-shown human detection sensor detects a person in the vicinity of the image processing apparatus 100.

If the return condition is not satisfied (ACT201-NO), the control part 24 does not perform the transition from the low power state to the normal state. On the other hand, if the return condition is satisfied (ACT201-YES), the control part 24 determines to perform the transition from the low power state to the normal state. In this case, the control part 24 performs processes of ACT202 to ACT 205 described below in the transition to the normal state.

First, the control part 24 causes the AFE 234 to perform an initialization process. In the initialization process, the AFE 234 initializes the storage contents of the memory included in the self apparatus. Next, the control part 24 causes the AFE 234 to start to output the CCD control signals to the CCD sensor 232. The CCD control signals are outputted from the AFE 234 to the CCD sensor 232, so that the driving of the CCD sensor 232 is started (ACT 202). Next, the control part 24 performs a black level correction process (ACT 203). Next, the control part 24 reads the correction information (gain value) stored in the memory 235 (ACT204). Next, the control part 24 stores the read correction information in the memory of the AFE 234 (ACT205). After the process of ACT 205 is performed, the AFE 234 uses the correction information stored in the memory of the AFE 234 and generates image data based on the output of the CCD sensor 232.

In the image processing apparatus 100 constructed as described above, the AGC process is performed in the transition from the normal state to the low power state. The correction information (gain value) obtained by the execution of the AGC process is stored in the memory in which information is not lost also in the low power state. Thus, the AGC process is not required to be performed in the transition from the low power state to the normal state. Accordingly, the time required to transition from the low power state to the normal state and to start reading of an image of an original document can be shortened.

As described above, the AGC process is not required to be performed when the low power state returns to the normal state. Thus, the first carriage 21 can be moved to the document detection position without being moved to the gain adjustment position. That is, the first carriage 21 can be previously moved to the document detection position in the transition to the low power state. Thus, the time required to transition from the low power state to the normal state and to start the reading of the image of the original document can be shortened.

### MODIFIED EXAMPLE

In the process of the transition to the low power state (particularly, the process of ACT106), the control part 24 is not necessarily required to move the first carriage 21 to the document detection position. A position where the control part 24 moves the first carriage 21 may be any position as long as the position is closer to the document detection position than the gain adjustment position.

1. An image reading apparatus comprising:
a processor that executes instructions that facilitate performance of operations, comprising:
acquiring an image of an original document based on an output of an imaging device;
controlling a position of a first carriage movable in a sub-scanning direction;
acquiring correction information used for correction of the output of the imaging device by turning on a light source of the first carriage at a first position;
storing the correction information; and
controlling a state of a self apparatus between a normal state in which the image of the original document is acquired and a low power state in which the image of the original document cannot be acquired but power consumption is lower than that in the normal state, in which
when the state transitions the self apparatus from the normal state to the low power state,
the first carriage is moved to the first position,
the correction information is acquired,
the correction information is stored, and
the first carriage is moved to a second position where the image of the original document placed on a document stand is acquired or a position closer to the second position than the first position at least after the correction information is acquired, wherein the acquiring of the image of an original document is performed by an image acquisition device comprising:
an image sensor to photoelectrically convert light reflected by the original document, and
a control substrate to generate image data of the original document based on an electric signal generated by photoelectric conversion of the image sensor, wherein the correction information is information to correct an output value of the electric signal outputted from the image sensor to a previously set target value, wherein the control substrate initializes a memory included in the control substrate when the low power state transitions to the normal state, and after a memory of the control substrate is initialized, the correction information stored in the storage part is written to the memory of the control substrate.

2. The apparatus according to claim 1, wherein
in response to first acquiring the image after the self apparatus transitions from the low power state to the normal state,
the operations further comprising acquiring the image of the original document by using the correction information during the low power state.

3. The apparatus according to claim 1, wherein
in response to first acquiring the image after the self apparatus transitions from the low power state to the normal state,
the operations further comprising moving the position of the first carriage to the second position without moving the position to the first position, and
acquiring the image of the original document when the position of the first carriage moves to the second position.

4. The apparatus according to claim 1, wherein
the first position is a position where an image of a white member as a reference is obtained.

5-7. (canceled)

8. The apparatus according to claim 1, wherein
when the self apparatus becomes the low power state, the control substrate stops an output of a control signal to the image sensor.

9. The apparatus according to claim 8, wherein
when the self apparatus transitions from the low power state to the normal state, the control substrate starts to output the control signal to the image sensor.

10. The apparatus according to claim 1, wherein
the control substrate is an analog front end (AFE).
